(19) United States
(12) Patent Application Publication
(10) Pub. No.: US 2005/0090289 A1
(43) Pub. Date: Apr. 28, 2005

(54) Mobile phone with multimedia display

(76) Inventors: Hsi-Che Lee, Taipei (TW); Tung-Hsing Pan, Taipei (TW); Mei-Jiuan Chen, Taipei (TW)

Correspondence Address: BIRCH STEWART KOLASCH & BIRCH, PO BOX 747, FALLS CHURCH, VA, 22040-0747, US

(21) Appl. No.: 10/692,718

(22) Filed: Oct. 27, 2003

(51) Int. Cl. H04B 1/00

(52) U.S. Cl. 455/566

(57) ABSTRACT

A mobile phone with multimedia display comprising a folding mobile phone with a CPU, memory, a timer, a communication interface, a mobile phone keypad, a mobile phone connecting port and a display interface built-in and an external big screen display, users can apply the mobile phone connecting port of the folding mobile phone linking to the computer, PDA or digital camera to transmit the image data to the communication interface and to the CPU then store the image data into memory, by the control of the CPU, the big screen display can display image data repeatedly as a multimedia display or automatic photo album.

### BACKGROUND OF THE INVENTION

I. Field of the Invention

This invention relates generally to a mobile phone with multimedia display and, more specifically, to a folding mobile phone with a big screen display externally that displays image data repeatedly to be applied as multimedia display or automatic photo album.

II. Description of the Prior Art

Heretofore, it is known that a mobile phone is in flat, long rectangular shape with display installed on the mobile phone directly; one major requirement of mobile phone is small in physical size and light in weight for users to carry, however if the physical size is too small, the display will be small relatively for users to see.

Some manufacturers improve the mobile phone design into folding style to make the mobile phones have larger working area but in smaller physical size for users to carry; the new design is in folding style with the display inside the folding area, users have to unfold the folding mobile phones to see the messages in the display, it is not very convenient for users; some new designs to have displays on both sides of the mobile phones, however booth displays are small in viewing area, the characters are very small to display multiple lines of messages and too less messages for larger characters, such scheme is still not very convenient for users to view the messages.

### SUMMARY OF THE INVENTION

It is therefore a primary object of the invention to provide a mobile phone with multimedia display with a big screen display externally that displays image data repeatedly to be treated as multimedia display or automatic photo album. In order to achieve the objective set forth, a mobile phone with multimedia display in accordance with the present invention is to have a folding mobile phone with a CPU, memory, a timer, a communication interface, a mobile phone push button set, a mobile phone connecting port and a display interface built-in and an external big screen display. Based on above structure, users can apply the mobile phone connecting port of the folding mobile phone link to the computer, PDA or digital camera to transmit the image data to the communication interface and to the CPU then store the image data into memory. By the control of the CPU, the big screen display can display image data repeatedly as a multimedia display or automatic photo album.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is another perspective view of the present invention;

FIG. 3 is a block diagram of the present invention;

FIG. 4 is a flowchart for filing routine in accordance with the present invention;

FIG. 5 is a flowchart for replay routine in accordance with the present invention;

FIG. 6 is a flowchart for turn-on routine in accordance with the present invention;

FIG. 7 is a flowchart for image change subroutine in accordance with the present invention;

FIG. 8 is a perspective view of another application in accordance with the present invention;

FIG. 9 is a block diagram of another application in accordance with the present invention.

### DESCRIPTION OF THE PREFERRED EMBODIMENT

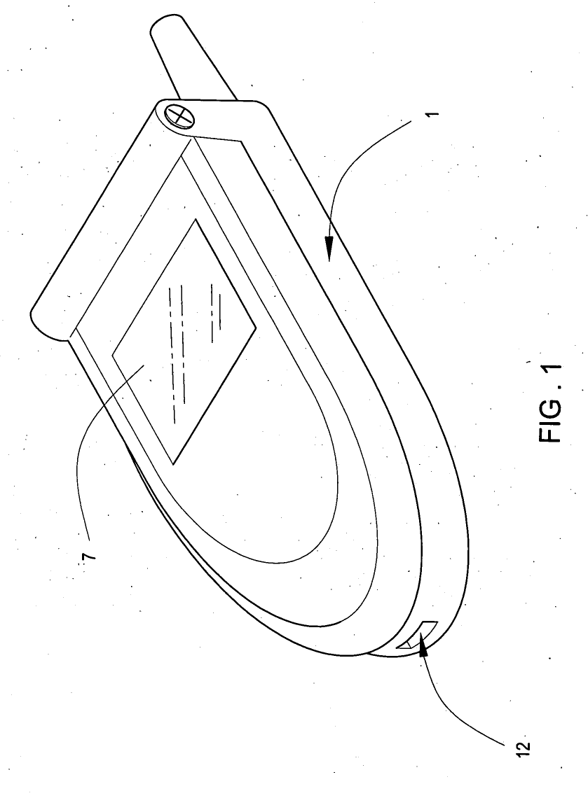

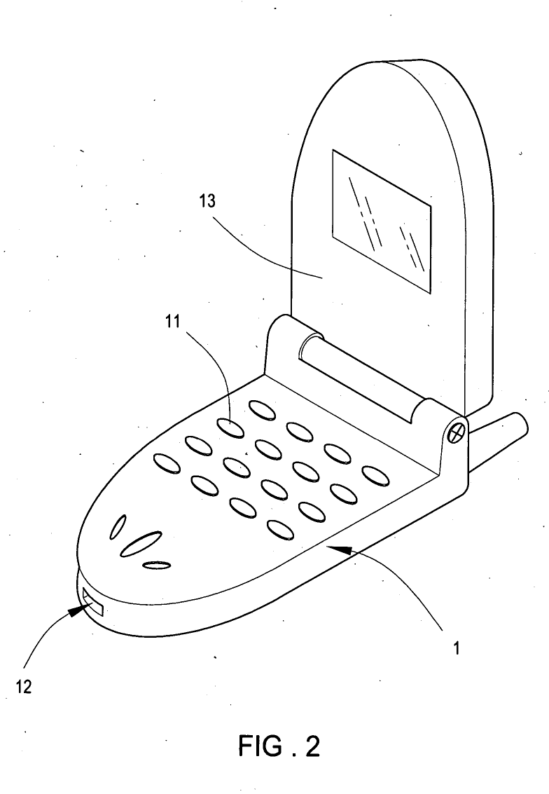

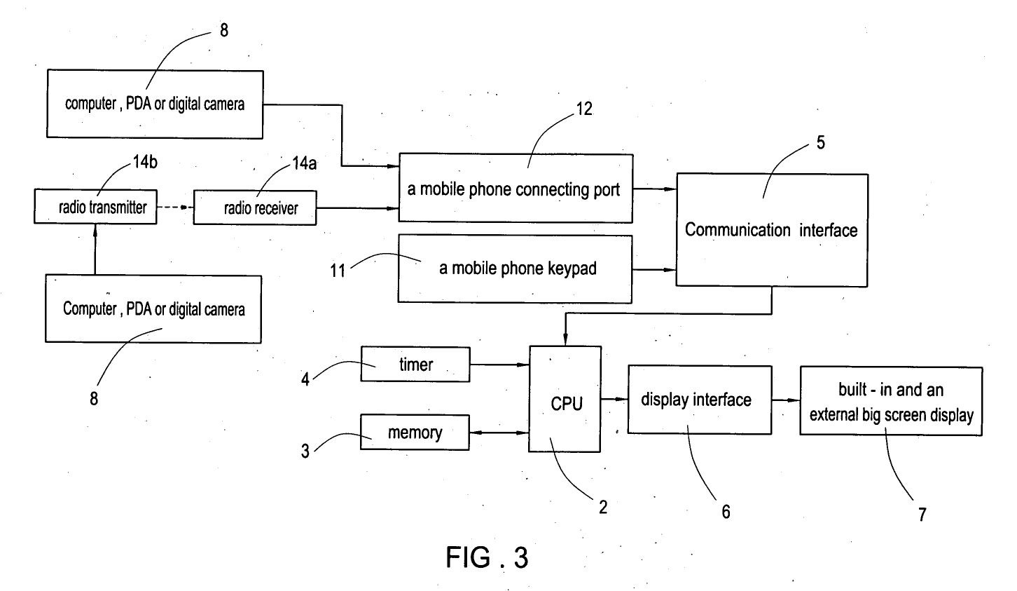

Referring to FIG. 1, FIG. 2 and FIG. 3, the present invention is composed of a folding mobile phone 1 with a CPU 2, memory 3, a timer 4, a communication interface 5, a mobile phone keypad 11, a mobile phone connecting port 12 and a display interface 6 built-in and an external big screen display 7. The functions of each component are described below:

The CPU 2 is installed inside the body of the folding mobile phone 1; the CPU controls the internal circuit of the present invention.

The memory 3 is connected to the CPU 2; the memory 3 is used to store data.

The timer 4 is connected to the CPU 2; the timer 4 is used to count and input the clock timing data to the CPU 2 for the CPU 2 to get timing data.

The communication interface 5 is connected to the CPU 2; the communication interface 5 transmits input signals.

The mobile phone keypad 11 is connected to the communication interface 5; the mobile phone keypad 11 enters command signals.

The mobile phone connecting port 12 is connected to the communication interface 5; the mobile phone connecting port 12 is linked to the computer, PDA or digital camera 8 to get the image data from the computers, PDA or digital camera 8 and transmit the image data to the CPU 2.

The display interface 6 is connected to the CPU 2; the display interface 6 transmits image data.

The big screen display 7 is connected to the display interface 6; the big screen display 7 is installed external to the body 13 of the folding mobile phone 1 to let the CPU 2 display images through the display interface 6 to the big screen display 7.

Based on above structure, users can apply the mobile phone connecting port 12 of the folding mobile phone 1 to link to the computer, PDA or digital camera 8 and transmit the image data from the computer, PDA or digital camera 8 to the communication interface 5, the communication interface 5 transmits image data into the CPU 2; by the control of the CPU 2, the image data are stored into the memory 3. When the program is running, the CPU 2 fetches timing information from the timer 4; by the setting of the program, the CPU 2 reads the image data from the memory 3 and transmits the image data to the display interface 6 and to have the big screen display 7 display those image data. After certain period of time, the CPU 2 reads another set of data, such scheme can change the displayed data or display same data repeatedly, the present invention can be used as a multimedia display or automatic photo album.

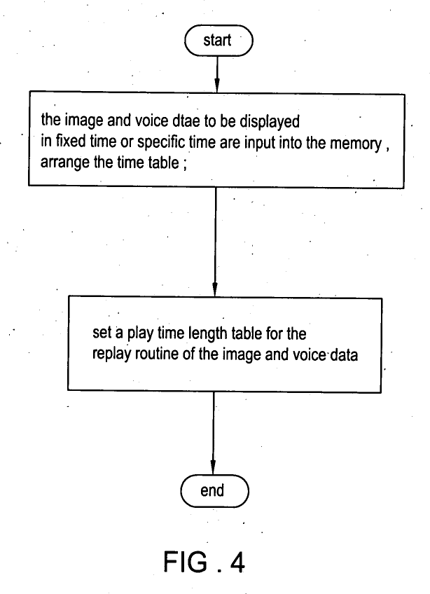

A filing routine controls the image or voice data input from the computer, PDA or digital camera 8, the flowchart of the filing routine as shown in FIG. 4. The filing routine arranges the image or voice data to be displayed on a fixed time or specific time inside the memory 3 into a play table of fixed time or specific time; the image and voice data to be displayed are input into the memory 3 and set a play time length table for the replay routine to play.

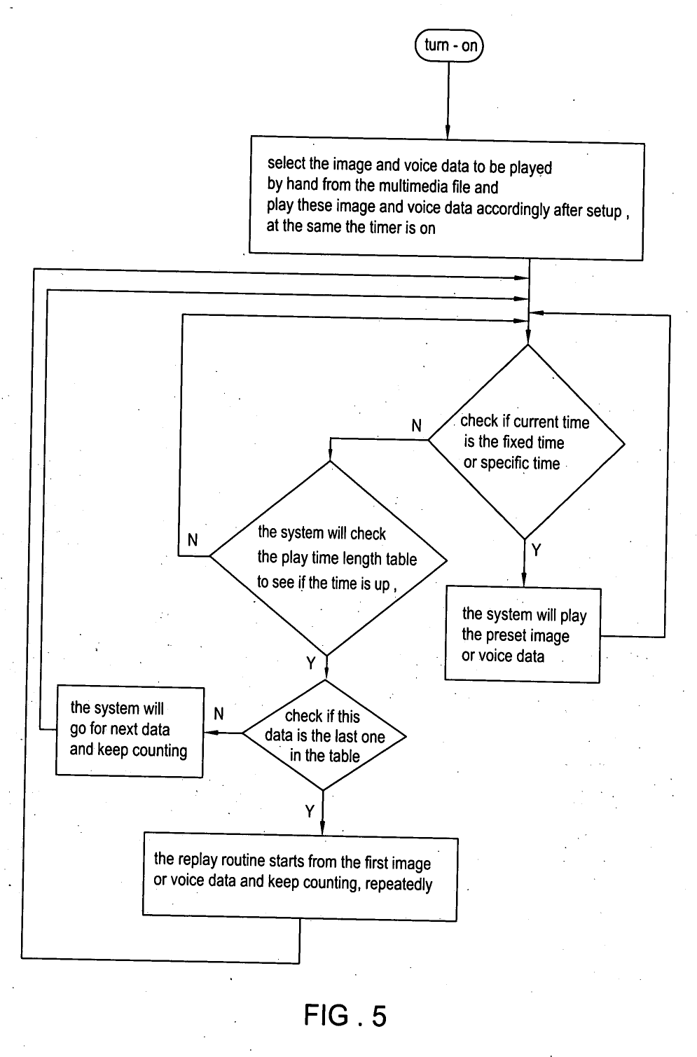

Referring to in FIG. 5, the flowchart of the replay routine. At the turn-on time, the replay routine can let users to select the image and voice data to be played by hand from the multimedia file and play these image and voice data accordingly after setup, at the same the timer 4 is on to see if current time is the fixed time or specific time; if current moment is the fixed time or specific time, the system will play the preset image or voice data, otherwise the system will check the play time length table to see if the time is up, if the response is “no”, the system returns back to the time checking sub-routine; if the response is “yes”, the replay routine plays next image or voice data and check to see if this data is the last one in the table, if the response is “no”, the system will go for next data and keep counting; if the response is “yes”, the replay routine starts from the first image or voice data and keep counting, the system can play image and voice data repeatedly.

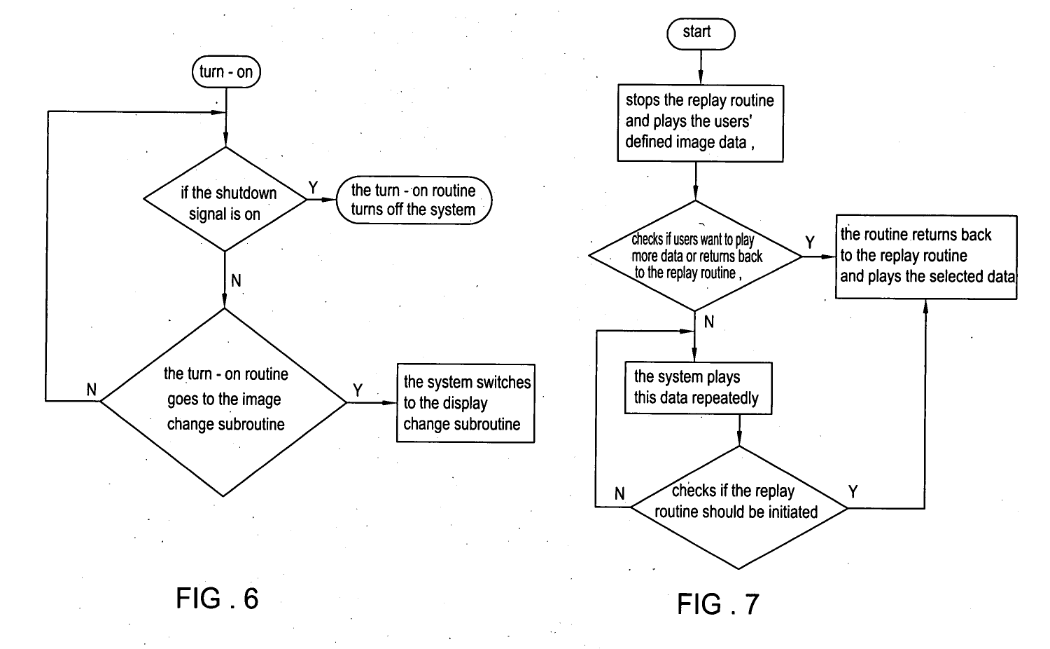

The turn-on routine, as shown in FIG. 6, checks if the shutdown signal is on, if the response is “yes”, the turn-on routine turns off the system directly, if the response is “no”, the turn-on routine goes to the image change subroutine; if the image change subroutine responses “yes”, the system switches to the display change subroutine, otherwise the turn-on routine returns back to check the shutdown signal.

The display change subroutine, as shown in FIG. 7, stops the replay routine in the beginning and plays the users' defined image data, then checks if users want to play more data or returns back to the replay routine, if the response is “yes”, the routine returns back to the replay routine and plays the selected data, if the response is “no”, the system plays this data repeatedly and checks if the replay routine should be initiated, if the response is “no”, the system plays previous data repeatedly, if the response is “yes”, the system plays the selected data and returns back to the replay routine.

The big screen display 7 is installed external to the body 13 of the folding mobile phone 1 to have the big screen display 7 displays different images repeatedly for better novelty to attract consumers.

The big screen display 7 is installed external to the body 13 of the folding mobile phone 1, users can check messages without open the folding mobile phone 1 to operate more conveniently.

The big screen display 7 has bigger display area that can display bigger characters and more lines of messages and characters, users can check and see more messages, more data for better and convenient effect.

As another application of the present invention, referring to FIG. 3, the mobile phone connecting port 12 links to a radio receiver 14a, the radio receiver 14a receives signals wirelessly from a radio transmitter 14b that is connected to the computer, PDA or digital camera 8.

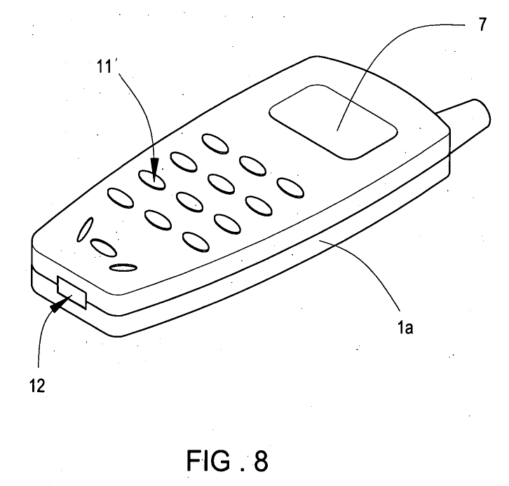

As another application of the present invention, referring to FIG. 8, the folding mobile phone 1 can be a non-folding mobile phone 1a designed for different requirements.

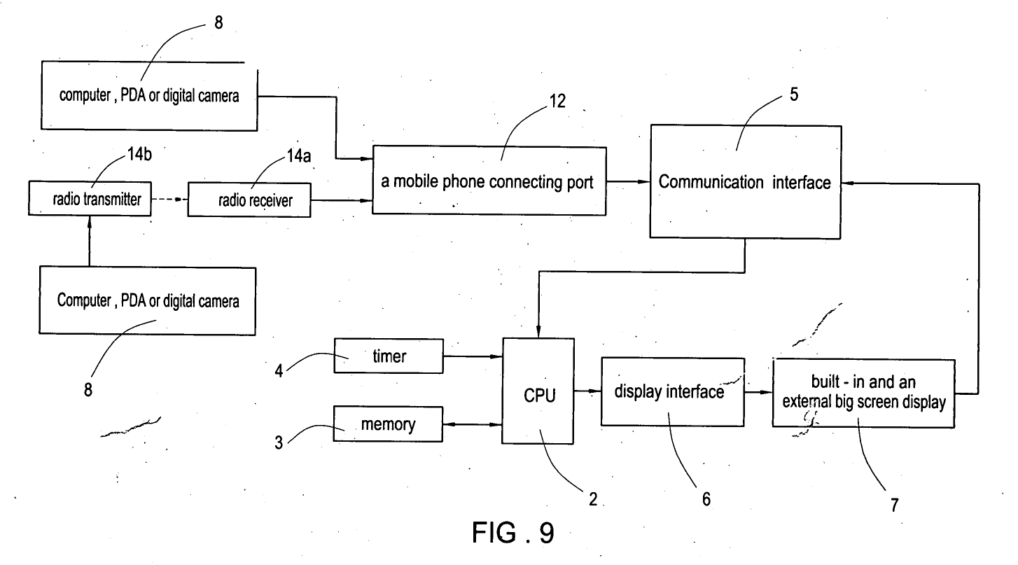

As another application of the present invention, referring to FIG. 9, the mobile phone keypad 11 and the big screen display 7 can be combined into a touch screen display 9 for the same results and effects.

While a preferred embodiment of the invention has been shown and described in detail, it will be readily understood and appreciated that numerous omissions, changes and additions may be made without departing from the spirit and scope of the invention.

1. A mobile phone with multimedia display comprising:
a CPU installed inside the body of the folding mobile phone to control the internal circuits;
memory connected to said CPU and used to store data;
a timer connected to said CPU and used to count and input the clock timing data to said CPU for said CPU to get timing data;
a communication interface connected to said CPU and transmitting input signals;
a mobile phone keypad connected to said communication interface and being entered command signals by users;
a mobile phone connecting port connected to said communication interface and linked to the computer, PDA or digital camera to get the image data and transmit the image data to said CPU;
a display interface connected to said CPU and transmitting image data; and
a big screen display connected to said display interface and installed external to the body of the folding mobile phone to let said CPU 2 display images through said display interface to said big screen display.

2. The mobile phone with multimedia display recited in claim 1, wherein said mobile phone connecting port linking to a radio receiver, said radio receiver receiving signals wirelessly from a radio transmitter connecting to the computer, PDA or digital camera.

3. The mobile phone with multimedia display recited in claim 1, wherein said mobile phone keypad and said big screen display being combined as a touch screen display.

4. The mobile phone with multimedia display recited in claim 1, wherein said folding mobile phone being a non-folding mobile phone.
